(19) United States
(12) Patent Application Publication
(10) Pub. No.: US 2025/0307902 A1
(43) Pub. Date: Oct. 2, 2025

(54) ENHANCED PRODUCT ACQUISITION

(71) Applicants: American Express Travel Related Services Company, Inc., New York, NY (US); American Express Services Europe Limited, London (GB); AMEX Canada, Inc., Toronto (CA)

(72) Inventors: Susan Arre, Eden Prairie, MN (US); Arielle Rebekah Cedeno, Brooklyn, NY (US); Hannah Louise Evans, London (GB); Morgan Snider Hatcher, Wayne, PA (US); Magdalena McGoldrick, Toronto (CA)

(21) Appl. No.: 18/622,011

(22) Filed: Mar. 29, 2024

(51) Int. Cl. G06Q 30/0601

(52) U.S. Cl. CPC G06Q 30/0633

(57) ABSTRACT

Disclosed are various embodiments for enhancing product acquisition. An acquisition order for the product is received, the acquisition order based at least in part on a first availability of the product. One or more user inputs for the product are received. Then, the acquisition order for the product is processed based at least in part on the one or more user inputs. Later, a second availability for the product is detected based at least in part on the plurality of platform data. Subsequently, the product is acquired based at least in part on the second availability.

### BACKGROUND

In general, inventory for items can vary over time, with items in high-demand selling out quickly. Moreover, products may only be offered for limited times, limited quantities, in batches, etc. to their users. Typically, a user has to continuously monitor the item for availability which requires a significant time commitment, leading to diminished customer satisfaction, and can be inconvenient. As a result, a user is likely to shop at other merchants, shop for different products or alternative products, or experience a loss of time and productivity. Accordingly, various approaches have been developed for facilitating purchase and acquisition of products through online marketplaces and platforms. These can include customer wish lists, item or product wait lists, pre-ordering of products or items, and in-store pickup of purchased items, among other approaches.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a network environment according to various embodiments of the present disclosure.

FIG. 2A is a flowchart illustrating one example of functionality implemented as portions of an application executed in a computing environment in the network environment of FIG. 1 according to various embodiments of the present disclosure.

FIG. 2B is a flowchart illustrating one example of functionality implemented as portions of an application executed in a computing environment in the network environment of FIG. 1 according to various embodiments of the present disclosure.

FIG. 3A is a flowchart illustrating one example of functionality implemented as portions of an application executed in a computing environment in the network environment of FIG. 1 according to various embodiments of the present disclosure.

FIG. 3B is a flowchart illustrating one example of functionality implemented as portions of an application executed in a computing environment in the network environment of FIG. 1 according to various embodiments of the present disclosure.

FIG. 4A is a flowchart illustrating one example of functionality implemented as portions of an application executed in a computing environment in the network environment of FIG. 1 according to various embodiments of the present disclosure.

FIG. 4B is a flowchart illustrating one example of functionality implemented as portions of an application executed in a computing environment in the network environment of FIG. 1 according to various embodiments of the present disclosure.

FIG. 5A is a sequence diagram illustrating one example of the interactions between the components of the network environment of FIG. 1 according to various embodiments of the present disclosure.

FIG. 5B is a sequence diagram illustrating one example of the interactions between the components of the network environment of FIG. 1 according to various embodiments of the present disclosure.

FIG. 6A is a user interface diagram according to various embodiments of the present disclosure.

FIG. 6B is a user interface diagram according to various embodiments of the present disclosure.

FIG. 6C is a user interface diagram according to various embodiments of the present disclosure.

FIG. 6D is a user interface diagram according to various embodiments of the present disclosure.

FIG. 6E is a user interface diagram according to various embodiments of the present disclosure.

FIG. 7 is a user interface diagram according to various embodiments of the present disclosure.

FIG. 8A is a user interface diagram according to various embodiments of the present disclosure.

FIG. 8B is a user interface diagram according to various embodiments of the present disclosure.

FIG. 8C is a user interface diagram according to various embodiments of the present disclosure.

FIG. 8D is a user interface diagram according to various embodiments of the present disclosure.

FIG. 9 is a user interface diagram according to various embodiments of the present disclosure.

FIG. 10 is a sequence diagram illustrating one example of the interactions between the components of the network environment of FIG. 1 according to various embodiments of the present disclosure.

### DETAILED DESCRIPTION

Disclosed are various approaches for enhancing product purchases using online e-commerce platforms or marketplaces. E-commerce platforms or marketplaces offer products for sale to their users. In some instances, an online marketplace or other online platform can offer products for limited times, limited quantities, in batches, etc. to their users. In some instances, a user may want to purchase an item that is out of stock on a merchant's platform. This can lead to clients seeking alternative items, alternative merchants, wasted time and resources, etc.

Previously, a user might have addressed these problems using various approaches. For example, the user could have shopped for the product at merchant B if merchant A did not have the item in stock. As another example, a user could purchase an alternative product (e.g., purchasing a blue shirt instead of a red shirt). Alternatively, a user could continuously monitor the ecommerce website for a restock and purchase the item when it is back in stock. In another example, the user could sign up to receive a notification through various channels (e.g., email, text message, app notifications, etc.). For example, a user could sign-up to be on a waitlist in order to receive notice when a product comes back in stock.

In contrast, the approaches herein introduce streamlined capabilities for product acquisition. For example, embodiments of the present disclosure allow a user to purchase an out-of-stock product or item immediately or automatically upon becoming available. An illustrative and non-limiting example can include a user navigating to an ecommerce website to purchase two shirts for $100.00 each that are currently out of stock. In this illustrative and non-limiting example, a user can activate the browser plugin to begin an automatic product reservation or product purchase upon availability. The user will be requested to login to the plugin with their pre-existing account, make a new account, or input data to begin the product reservation or product purchase upon availability. Once the user inputs the data and authenticates the order, the plugin can communicate the order with the merchant.

In another example, embodiments of the present disclosure allow the user to select logistical steps for the product in the order. For example, the user can select to pick up the order in a brick-and-mortar location of the merchant. In some instances, the user can select to have the merchant ship the order. In some approaches, the user can select to pick up a portion of the order and have the remaining order shipped.

In another example, embodiments of the present disclosure introduce an enhanced product acquisition system that dynamically determines product availability using platform data from the merchant. Additionally, embodiments of the present disclosure integrate secure user authorization techniques and methods to authenticate and finalize acquisition orders. For example, the user can be required to authenticate using a password, two-factor authentication, a biometric key, etc. In some instances, embodiments of the present disclosure can detect, based at least in part on the user interface of the user device or the platform data that a product is out of stock. The embodiments of the present disclosure can allow the user to place an acquisition order, which is authenticated using a secure method, request inputs from the user for the product, and finalize the order. The embodiments of the present disclosure can consistently query the platform or receive updated platform data to determine availability of the product select by the user. The embodiments of the present disclosure can automatically use discount codes, rewards, or other benefits before purchasing the product on behalf of the user.

In another example, embodiments of the present disclosure can notify a user on product availability or post-acquisition. For example, the user can receive a notification that two shirts the user selected for acquisition are in stock. The notification can be sent through email, SMS/text messages, or be a platform-based notification. In some instances, the notification can contain an acquisition identifier or other relevant information.

In some instances, embodiments of the present disclosure can offer suggestions based at least in part on the original user input, user preferences, past transaction history, and other user information. For example, if two shirts in blue are not available, but two shirts are available in green, the user could be presented with the alternative option. In some examples, the user could receive a notification with the alternative options.

Techniques described herein of enhanced product acquisition provide a significant technical improvement by reducing server request frequencies (e.g., continuous query requests from user(s) to check product availability, etc.), data retrieval processes (e.g., fetching inventory status/product status, product details, etc.), and improve data and improved data analysis and reporting (e.g., understanding product demand, analyzing patterns, calculating interest, etc.). The techniques described herein of enhanced product acquisition can also provide a significant technical benefit such as refining user experience (e.g., using a single application, saving time, etc.), personalized experiences, and reduced operation costs (e.g., less equipment, fewer personnel, etc.). Moreover, the various embodiments of the present disclosure increase sell-through for merchants as well as foot-traffic at merchant brick-and-mortar locations. Inventory projection is also simplified for merchants by allowing merchants to understand the level of demand for inventory by allowing for customers to automatically purchase merchandise when it is restocked. Further, various embodiments of the present disclosure improve the user experience for customers by providing greater access to currently sold out items that will be restocked.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

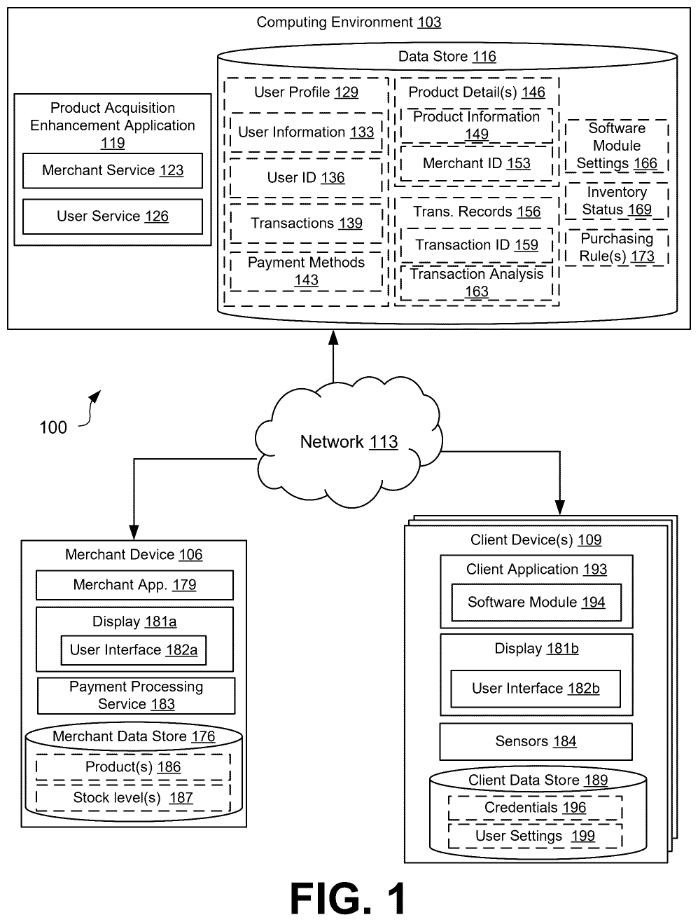

As illustrated in FIG. 1, shown is a network environment 100 according to various embodiments. The network environment 100 can include a computing environment 103, merchant device 106, and a client device 109, which can be in data communication with each other via a network 113.

The network 113 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 113 can also include a combination of two or more networks 113. Examples of networks 113 can include the Internet, intranets, extranets, virtual private networks (VPNs), and similar networks.

The computing environment 103 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 103 can employ a plurality of computing devices that can be arranged in one or more server banks or computer banks or other arrangements. Such computing devices can be located in a single installation or can be distributed among many different geographical locations. For example, the computing environment 103 can include a plurality of computing devices that together can include a hosted computing resource, a grid computing resource, or any other distributed computing arrangement. In some cases, the computing environment 103 can correspond to an elastic computing resource where the allotted capacity of processing, network, storage, or other computing-related resources can vary over time.

Various applications or other functionality can be executed in the computing environment 103. The components executed on the computing environment 103 include a Product Acquisition Enhancement Application (PAEA) 119, and other applications, services, processes, systems, engines, or functionality not discussed in detail herein. Moreover, the PAEA 119 can contain component applications such as a merchant service 123 and a user service 126 which can be executed by the computing environment 103.

Also, various data is stored in a data store 116 that is accessible to the computing environment 103. The data store 116 can be representative of a plurality of data stores 116, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 116 is associated with the operation of the various applications or functional entities described below. This data can include one or more user profiles 129, user information 133, user identifier (ID) 136, transaction 139, payment methods 143, product detail(s) 146, product information 149, merchant identifier (ID) 153, transaction record(s) 156, transaction identifier (ID) 159, transaction analysis 163, software module settings 166, inventory status 169, purchasing rules 173, and potentially other data.

Individual user profile(s) 129 can represent information related to individual users or clients of an e-commerce platform or marketplace. For example, a customer of an e-commerce might have a user account representing the user and his or her relationship with one or more merchants. In some instances, the user profile 129 can represent personalized datasets associated with users or clients on the platform. Accordingly, a user profile 129 can include a user ID 136 that uniquely identifies a user profile 129 with respect to another user profile 129. A user profile 129 can also include one or more transactions 139, which serve to identify a previously completed transaction or pending transaction 139 the user has authorized. In some examples, the user ID 136 can be a customer identification number, an account number, a username, or an email address. In some implementations, individual users may have multiple user IDs 136 associated with their user profile 129, such as when a user has separate accounts for different merchants to maximize rewards programs, track transactions, or other benefits. In some examples, the user ID 136 could be used to authenticate the user into the user interface 182b to manage the one or more transactions 139, payment methods 143, or user IDs 136. The user profile 129 can further include user behavior analysis, purchase histories, saved products, interaction data, etc.

User information 133 can represent generalized data and personalized data about a user. In some instances, the user information 133 can be personally identifiable information (PII). In some other examples, the user information 133 can include general user behavior and/or patterns. In some instances, user information 133 can be used to propose alternate products. In other instances, user information 133 can be used to offer logistical data for product retrieval. In some instances, the user information 133 can include user preferences. For example, the user could select a UI/UX preference, notification settings and preferences, preferred payment methods, and other relevant preferences.

User ID 136 can represent a customer ID number, an account number, a username, or an email address. In some implementations, individual users may have multiple user IDs 136 associated with their user profile 129, such as when a user has separate accounts for different merchants to maximize rewards programs, track transactions, or other benefits. In some examples, the user ID 136 could be used to authenticate the user into the user interface 182b to manage the one or more transactions 139, payment methods 143, or user IDs 136.

Transactions 139 can represent a recorded exchange between the user and a merchant. In some embodiments, the one or more transactions 139 can represent a purchase, a pre-authorization, or a store reservation. The transaction 139 can be linked to the transaction record 156. In some examples, the one or more transactions 139 can include information regarding products, items, or services involved, quantity, payment method 143, any applied rewards or discounts, and the status of the transaction 139. In some examples, the transaction 139 could be used by the merchant application 179. In other examples, the transaction 139 could represent a product purchase, a service, a subscription, or other relevant forms of transactions.

Payment methods 143 can represent various ways a user can make a payment to conduct business or perform a transaction 139 with a merchant. In some examples, payment methods 143 can be payment accounts that can be used to make a payment from one party to another, such as from a user or client to a merchant. Examples of payment methods 143 can include credit cards, charge cards, debit cards, checking accounts, money market accounts, or other demand deposit, stored value, or credit accounts. In some instances, the payment methods can be a payment wallet such as Samsung Pay, Google Wallet, or Apple Pay.

Product details 146 can represent a plurality of information about a product 186. In some instances, the product details can include product information 149 and information about the merchant. In some instances, the product details 146 contain a merchant ID for each product 186 to determine the merchant selling a product 186.

Product information 149 can represent information about a product related to product categories, brand information, associated products, and other relevant data. In some examples, the product details can provide information about a plurality of products 186.

Merchant ID 153 acts as a unique identifier for merchants or sellers on the platform. In some examples, the merchant ID 153 can be used to track transactions 139, track products 186, and manage interactions associated with a merchant. In some examples, the merchant ID can be used to organize and/or manage a merchant.

Transaction records 156 can represent information associated with the one or more transactions 139 of a user profile 129. The transaction records 156 can be created in response to the transaction 139 associated with the user profile 129. Transaction records 156 can store relevant data such as the payment method 143 of the user profile 129 used to fund or pay for the transaction 139, the amount of the transaction, the merchant identifier of the merchant who submitted the transaction for authorization as the merchant of record, a merchant type, a transaction date, a transaction type, a description, and other suitable transaction data elements.

A transaction ID 159 can represent a unique identifier assigned to each transaction 139. In some examples, the transaction ID 159 can represent any identifier that uniquely identifies one transaction 139 with respect to another and, therefore, one transaction record 156 with respect to another.

A transaction analysis 163 can represent an evaluation and interpretation of transaction data to gain insights into user behavior, market trends, and build a user profile 129. In some instances, the transaction analysis 163 can be used to generate reports. In some examples, a merchant can request the transaction analysis 163 to develop marketing strategies.

Software module settings 166 can represent features and behaviors of the software module 194 on a client device 109. In some instances, the software module settings 166 can represent user preferences of the software module 194 within the client application 193. In some instances, the software module settings 166 can be representative of features and behaviors of the PAEA 119.

Inventory status 169 can represent a dataset on real-time information on stock levels 187 of products at one or more merchants. In some instances, the inventory status 169 can be an identifier such as dead stock, out of stock, or available. In other instances, the inventory status 169 could be updated at a set time frequency (e.g., one minute, one hour, one day, one week, one month, etc.). In some examples, the inventory status 169 of a product 186 can be a first availability, a second availability, or a third availability. In some examples, the first availability, the second availability, and the third availability can be one of a in stock, out of stock, unavailable, or discontinued.

Purchasing rules 173 can represent the rules for purchasing the product requested by the user. In some instances, the purchasing rules 173 can determine when to automatically purchase the product upon restock. In some instances, the one or more inputs provided by the user can be used to set the one or more purchasing rules 173. For example, the user could have input the maximum amount of time to wait for the product to become available.

The product acquisition enhancement application 119 can be executed to enhance product reservations, product purchases, and/or purchasing services. The PAEA 119 can have a merchant side and a user side. The PAEA 119 can use analytics, real-time data, and use-specific preferences to provide an automatic purchase of products and/or services to users. The PAEA 119 can offer analytics such as real-time market trends, potential promotions, transaction details, customer behaviors, and other related analyses. In some instances, machine learning and/or AI algorithms can be implemented in the PAEA 119. By implementing machine learning and/or AI algorithms, the PAEA 119 can learn from user interactions, user feedback, user behavior, provide refined recommendations, and other related features. In some examples, the PAEA 119 can be executed to automatically purchase a product when the item is restocked after a use submits an acquisition order. In other examples, the PAEA 119 can offer features such as product reviews loyalty program integrations, discounts and/or purchase offers, price comparisons, and other product related information. In other examples, the PAEA 119 can communicate with the client application 193 and/or the merchant application 179 simultaneously. In other examples, the PAEA 119 can provide a personalized and analytical approach to product acquisitions.

The PAEA 119 can increase user engagement and spend, increase omnichannel spend, increase traffic to brick-and-mortar locations, empower the user to purchase a sought-out product, and offer an enhanced purchasing or acquiring experience.

The merchant device 106 is representative of one or more merchant devices 106 that can be coupled to the network 113. The merchant device 106 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The merchant device 106 can include one or more displays 181a, such as liquid crystal displays (LCDs), gas plasma-based flat panel displays, organic light emitting diode (OLED) displays, electrophoretic ink (“E-ink”) displays, projectors, or other types of display devices. In some instances, the display 181a can be a component of the merchant device 106 or can be connected to the merchant device 106 through a wired or wireless connection. In some instances, the merchant device 106 can include one or more sensors, such as a location detection unit, an accelerometer, a gyroscope, a camera, fingerprint sensor, iris sensor, and other suitable sensors.

Various data is stored in a merchant data store 176 that is accessible to the merchant device 106. The data stored in the merchant data store 176 is associated with the operation of the various applications or functional entities described below. This data can include product(s) 186, the stock level(s) 187, and potentially other data.

The products 186 can include an array of items, services, digital goods, and other similar merchant offerings for sale by a plurality of merchants. The products 186 can be physical or digital goods, electronics, apparel, etc. In some examples, a product 186 could be associated with a stock keeping unit (SKU). A SKU can be a unique identifier used by merchants to manage inventory and distinguish between similar products in inventory. In other examples, the product 186 could have a description, pricing information, pictures and/or videos, descriptions, reviews, and other relevant metadata. In other examples, the products 186 can be categorized and/or tag based at least in part on brand, category, ratings, price, availability, and other relevant factors. In some instances, the products 186 can include unique identifiers (e.g., SKU number, barcode number, QR code, etc.) to streamline purchase, verification, and/or updating the stock levels 187. In other instances, the products 186 could be augmented to contain interactive features such as virtual try-ons, 3D rendering in a picture or current space, etc. to facilitate an immersive shopping experience.

The stock levels 187 can represent the real-time inventory status of the plurality of products 186 available for sale by a merchant. The stock levels 187 can provide user and/or merchants information on products in stock, products out of stock, and other errors with the stock level 187 of a product 186. In some examples, products 186 can include multiple SKUs wherein the stock levels 187 can provide a granular view of the individual SKUs of the products 186. In some examples, the stock levels 187 can be used to perform an audit. In other examples, the stock levels 187 can be used to minimize discrepancies in total purchases, stock on-hand, and stock sold.

The merchant device 106 can be configured to execute various applications such as a merchant application 179 or other applications. The merchant application 179 can be executed in a merchant device 106 to access network content served up by the computing environment 103 or other servers, thereby rendering a user interface 182a on the display 181a. To this end, the merchant application 179 can include a browser, a dedicated application, or other executable, and the user interface 182a can include a network page, an application screen, or other user mechanism for obtaining user input. The merchant device 106 can be configured to execute applications beyond the merchant application 179 such as email applications, social networking applications, word processors, spreadsheets, or other applications.

Additionally, the merchant device 106 can be configured to execute various applications such as a merchant application 179 or other applications. The merchant application 179 can be executed to interface with the product acquisition enhancement application 119, the merchant service 123, or the user service 126. The merchant application 179 can be used to display user interfaces for the product acquisition enhancement application 119 and provide data to the merchant service 123 or user service 126 related to the enhancement of product acquisition.

In some examples, the merchant device 106 can have a payment processing service 183. The payment processing service 183 can act as an intermediary for facilitating transactions between users and merchants. The payment processing service 183 can be used to collect payments, allow a user to use a variety of payment methods 143, initiate purchases and pre-authorization charges, and other processing of transactions. In some instances, the payment processing service 183 can accept various payment methods 143. The payment processing service 183 can include encryption and security protocols for handling sensitive information and/or process transactions. In some examples, the payment processing service 183 can provide merchants with reports and analytics regarding average transaction size, potential fraudulent transactions, and other relevant business metrics.

The client device 109 is representative of a plurality of client devices that can be coupled to the network 113. The client device 109 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 109 can include one or more displays 181b, such as liquid crystal displays (LCDs), gas plasma-based flat panel displays, organic light emitting diode (OLED) displays, electrophoretic ink (“E-ink”) displays, projectors, or other types of display devices. In some instances, the display 181b can be a component of the client device 109 or can be connected to the client device 109 through a wired or wireless connection. In some instances, the client device 109 can include one or more sensors 184, such as a location detection unit, an accelerometer, a gyroscope, a camera, fingerprint sensor, iris sensor, and other suitable sensors.

The sensor 184 can be used for determining physical merchant locations available for product pickup based at least in part on the location of the client device 109. Additionally, in some examples, the sensor 184 can be used for dynamically determining the layout of the user interfaces rendered on the display 181b. For instances, text and/or graphics relocated based at least in part on a detected orientation (e.g., portrait or landscape) of the display 181b on the client device 109. The text and graphics can be dynamically relocated based on detected gestures (via a touchscreen display) on the display 181b. The text and graphics can be dynamically relocated in order to create viewable area in the display 181b for other related text and/or graphics. In some examples, the sensors 184 could be used to capture a biometric marker of the user.

Various data is stored in a client data store 189 that is accessible to the client device 109. The data stored in the client data store 189 is associated with the operation of the various applications or functional entities described below. This data can include credentials 196, the user settings 199, and potentially other data.

The credentials 196 can include data for authenticating the client device 109 with the computing environment 103. Some examples of credentials 196 can include passwords, tokens, biometric keys, session key, and other suitable credential data. In some instances, the credentials 196 can be used to authenticate users into the PAEA 119. The credentials 196 can be securely stored and encrypted to avoid misuse.

The client device 109 can be configured to execute various applications such as a client application 193 or other applications. The client application 193 can be executed in a client device 109 to access network content served up by the computing environment 103 or other servers, thereby rendering a user interface 182b on the display 181b. To this end, the client application 193 can include a browser, a dedicated application, or other executable, and the user interface 182b can include a network page, an application screen, or other user mechanism for obtaining user input. The client device 109 can be configured to execute applications beyond the client application 193 such as email applications, social networking applications, word processors, spreadsheets, or other applications. Moreover, the client application 193 can contain component applications such as a software module 194 which can be executed by the client device 109.

Additionally, the client device 109 can be configured to execute various applications such as a client application 193, software module 194, or other applications. The client application 193 can be executed to interface with the product acquisition enhancement application 119, the merchant service 123, or the user service 126. The client application 193 can be used to display user interfaces for the PAEA 119 and provide data to the user service 126, merchant service 123 or the payment processing service 183.

The software module 194 can be a browser plug-in, software application, mobile application, web application, or other similar application. The software module 194 can be executed to interface with the product acquisition enhancement application 119, the merchant service 123, or the user service 126. The software module 194 can be used to display user interfaces for the PAEA 119 and provide data to the user service 126, merchant service 123 or the payment processing service 183. In some instances, the software module 194 can be an extension or additional feature of the client application 193. In some instances, the software module settings 166 can represent user preferences of the software module 194 within the client application 193. The software module 194 can be used by a user to reserve an out-of-stock item or pre-authorize a purchase of an out-of-stock item. The software module 194 can be installed by the user as a browser plug-in, dedicated software application, mobile application, or be accessed as a web application.

Next, a general description of the operation of the various components of the network environment 100 is provided. Although the following description provides a general description of the interactions between the various components of the network environment 100, other interactions are also encompassed by the various embodiments of the present disclosure.

To begin, a merchant can offer for sale products 186 and/or services, digital goods, etc. to users, clients, businesses, etc. Often times, users/clients will come across products 186 and/or services that are out of stock or unavailable at that time, but the user is interested in purchasing the out-of-stock or unavailable product. The PAEA 119 integrates with online platforms, e-commerce sites, and merchants. A user can use the PAEA 119 to at least automatically purchases items upon restock and/or reserve items for in-store assessment or purchase. The PAEA 119 can be a web browser plug-in, web application, computer application, mobile application, or other type of application. The PAEA 119 can contain a user profile 129, product details 146, transaction records 156, software module settings 166, inventory status 169, and purchasing rules 173. The PAEA 119 can be used by merchants and users. The PAEA 119 can integrate with a merchant platform to inherit product details 146 and inventory status 169. The PAEA 119 can store a user profile 129 containing user information 133, a user ID 136, transaction 139, and payment methods 143.

To allow the user to reserve an out-of-stock or currently unavailable product, the user can use the PAEA 119. First, the user can navigate to the merchant platform and select the out of stock or unavailable product on the user interface 182b. The user will be prompted to login using their credentials 196 to fetch their user profile 129. In some instances, the user can continue to use the PAEA 119 as a guest. In other instances, the user can create a new account for the PAEA 119. Once the user has selected the product, the user will be prompted to enter inputs. In some instances, the inputs will be auto filled based on the user profile 129. For example, the user can be asked to input colorway options, size, length, waist size, maximum wait time, maximum price, etc. The user can read the terms and conditions to authorize the PAEA 119 to automatically purchase and/or reserve the product. In some instances, the user may have to authenticate the acquisition order using an authentication method such as inputting a password, verifying using two factor authentication, providing biometric authentication, providing credentials 196, or other similar secure authentication methods.

Upon submitting the order, the user service 126 of the PAEA 119 can send a user a confirmation notification. In some instances, the user can provide notification preferences. Next, the merchant service 123 of the PAEA 119 will process the acquisition order and send it to the merchant application 179.

The merchant application 179 can query the stock levels 187 to determine the current stock level 187 of a product 186 requested by the user in the acquisition order. If the product is unavailable or out-of-stock, the merchant application 179 can determine the maximum time provided by the user to check continue querying the stock level 187 for a product 186. The merchant application 179 can query the stock levels 187 continuously or at set time intervals. Upon availability of a product 186, the merchant application 179 can initiate a pre-authorization request to the user selected payment method 143. The pre-authorization charge can be processed by the payment processing service 183. The merchant application 179 will continue processing the acquisition order for a product 186 and generate an acquisition ID for the acquisition order. Upon completion of the acquisition order, the merchant application 179 can notify the PAEA 119 and the user via the client application 193 or other similar methods of the status of the acquisition order. In some instances, the merchant application 179 can generate a logistical dataset based at least in part on the user preference of reserving the product for a brick-and-mortar store or shipping the product 186. Additionally, the merchant application 179 can update the stock levels 187 to update the inventory status 169 based at least in part on the acquisition order.

In some instances, the product 186 could remain out of stock or it could be discontinued. In these instances, the merchant application 179 can notify the user and the PAEA 119 if the product 186 will not be stocked. Additionally, the merchant service 123 can provide the merchant application with user information to generate suggests or recommendations for alternate products 186. The suggestion and/or recommendation can be presented to the user on the user interface 182b or be sent via notification to a user preferred communication channel (e.g., email, SMS, mobile application notification, etc.). The user can view all completed, in-progress, and pending transactions 139 in the PAEA 119. In some instances, the user can modify a transaction 139.

Upon confirmation of the acquisition order, the user can pick up the product 186 in a brick-and-mortar location using the acquisition ID. If the user elected for the product 186 to be shipped, the user can be provided with a tracking number or shipment status of the product 186. The user service 126 of the PAEA 119 will send a receipt to the user upon completion of the transaction.

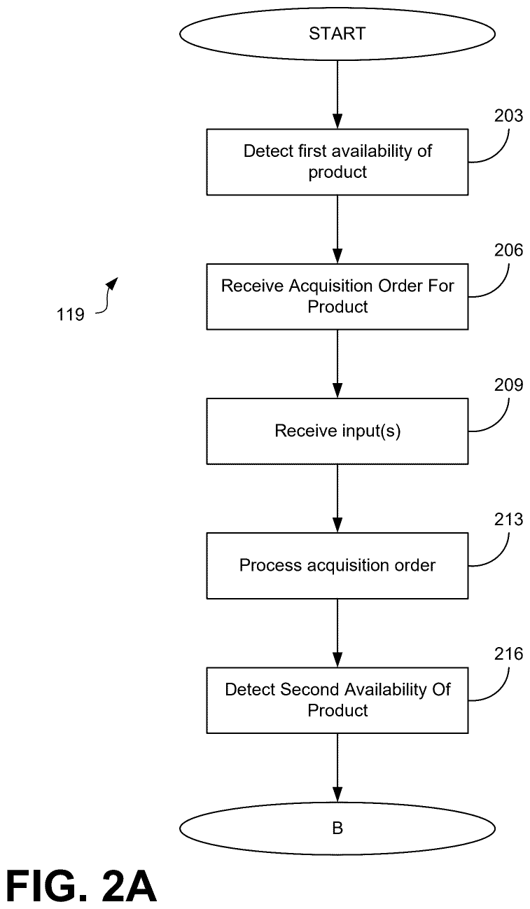

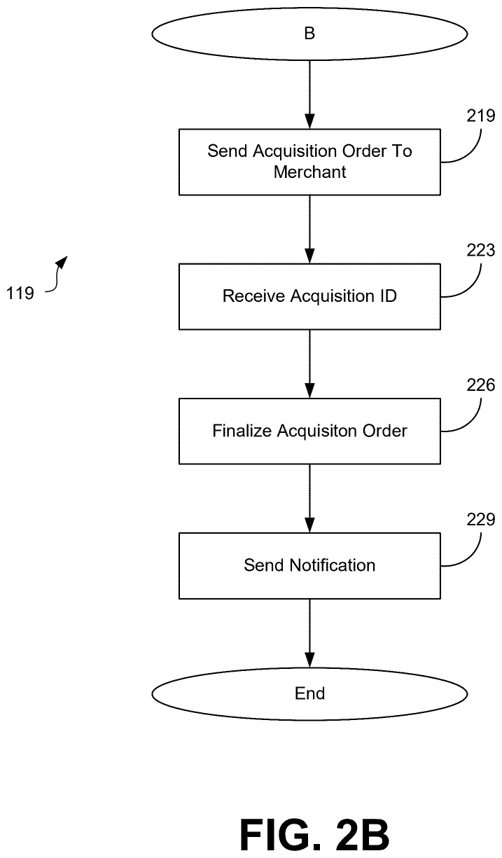

Referring next to FIGS. 2A and 2B, shown is a flowchart that provides one example of the operation of a portion of the product acquisition enhancement application 119. The flowchart of FIGS. 2A and 2B provides merely an example of the many different types of functional arrangements that can be employed to implement the operation of the depicted portion of the product acquisition enhancement application 119. As an alternative, the flowchart of FIGS. 2A and 2B can be viewed as depicting an example of elements of a method implemented within the network environment 100.

Beginning with block 203, the product acquisition enhancement application 119 can detect a first availability of a product 186. In some instances, the first availability can be determined based at least in part on the inventory status 169. In other instances, the PAEA 119 can determine the first availability based at least in part on the text or other relevant markers on the ecommerce platform.

At block 206, the product acquisition enhancement application 119 can receive an acquisition order for a product 186. In some instances, the acquisition order can be for a plurality of products 186. In some examples, the acquisition order can be authenticated based at least in part on the credentials 196 provided by the user. In other instances, the order can be authenticated by a secure user authorized method. The secure user authorized method can be at least one or more of a password authentication, a multi-factor authentication, or a biometric authentication.

At block 209, the product acquisition enhancement application 119 can receive one or more user inputs for the product 186. In some examples, the user inputs can be prefilled based at least in part on the user profile. In other examples, the inputs can be at least one of providing a quantity, maximum price, or a maximum time frame to automatically purchase. In other examples, the inputs can be at least one or more of providing a color, size, width, length, etc. based at least in part on the product information 149 or the product details 146.

At block 213, the product acquisition enhancement application 119 can process the acquisition order for the product 186 based at least in part on the one or more user inputs. In some examples, the acquisition order can be processed based at least in part on a user providing a secure user authorized method.

At block 216, the product acquisition enhancement application 119 can detect a second availability for the product 186 requested by the user in the acquisition order. In some instances, the second availability can be detected based at least in part on the platform data. In other instances, the second availability can be detected based at least in part on the inventory status 169. In other instances, the second availability can be detected based at least in part on a manual input by the merchant.

At block 219, the product acquisition enhancement application 119 can send the acquisition order to the merchant. In other examples, the PAEA 119 can confirm the receipt of the acquisition order with the merchant.

In some examples, the product acquisition enhancement application 119 can perform an acquisition action for the product 186. In other instances, the PAEA 119 can acquire the product 186 based at least in part on the second availability. In other instances, the PAEA 119 can reserve the product 186 for in-store pick up at a brick-and-mortar location.

At block 223, the product acquisition enhancement application 119 can receive an acquisition ID for the acquisition order. In other instances, receiving an acquisition ID could imply a successful order. In some examples, the acquisition ID can be the transaction ID 159.

At block 226, the product acquisition enhancement application 119 can finalize the acquisition order for the user. In some instances, the PAEA 119 can finalize the acquisition order by updating at least one or more of the user profile 129, transaction records 156, or the transactions 139.

At block 229, the product acquisition enhancement application 119 can send a notification to the user. In some examples, the PAEA 119 can send the acquisition ID in the notification.

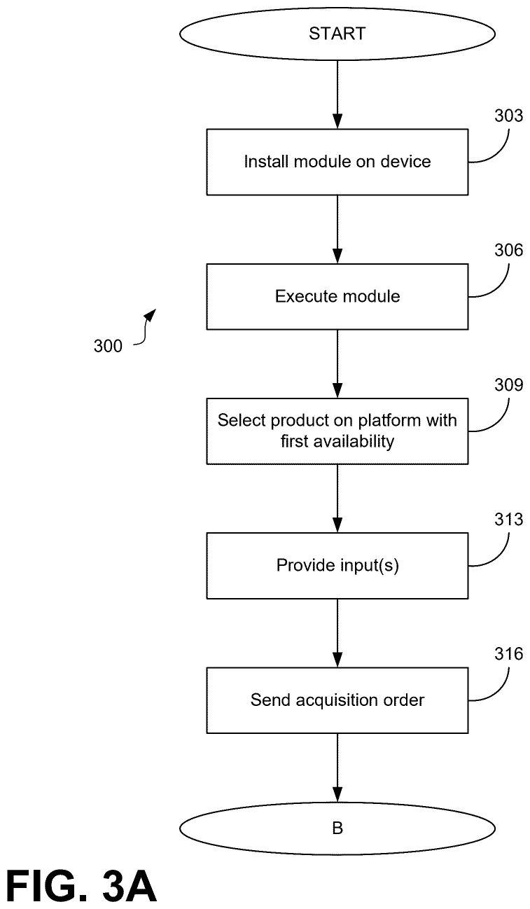

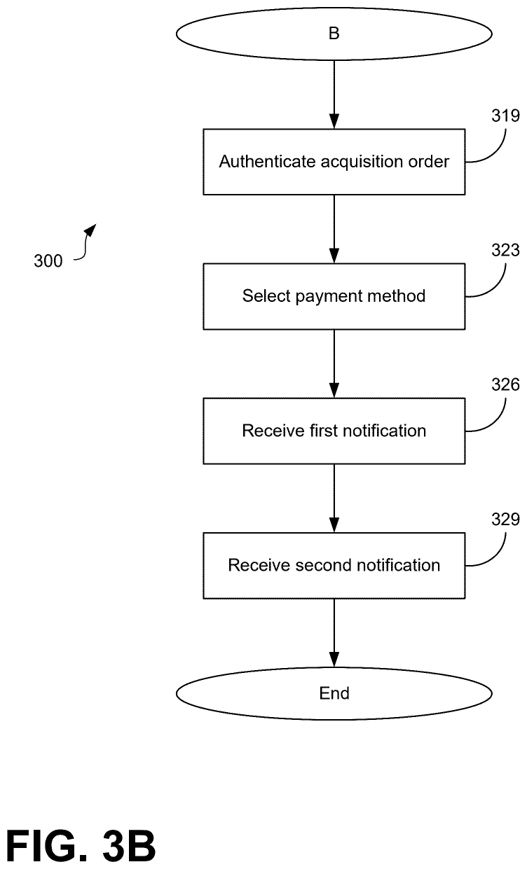

Referring next to FIGS. 3A and 3B, shown is a flowchart 300 that provides one example of the operation of a portion of the product acquisition enhancement application 119. The flowchart of FIGS. 3A and 3B provides merely an example of the many different types of functional arrangements that can be employed to implement the operation of the depicted portion of the product acquisition enhancement application 119. As an alternative, the flowchart of FIGS. 3A and 3B can be viewed as depicting an example of elements of a method implemented within the network environment 100.

Beginning with block 303, the user of the client device 109 can install a software module 194 on the client device 109. The software module 194 can be a browser plug-in, a web application, a computer application, or a mobile application.

At block 306, the user of the client device 109 can execute the software 194 module on the client device 109. In some examples, the software module 194 can be executed in the client application 193. For example, a user can open a web browser and launch the software module 193 by clicking on the plug-in. The software module 194 can be executed by launching the browser plug-in, navigating to the web application, launching the computer application, or launching the mobile application.

At block 309, the software module 194 of the client device 193 can select a product on the merchant platform with a first availability. In some instances, the client application 193 can select a product on the merchant platform with a first availability. In some instances, the first availability can be out of stock. In other instances, the first availability can be unavailable.

At block 313, the software module 194 of the client application 193 can provide an input to the PAEA 119. In some instances, the client application 193 can provide a plurality of inputs to the PAEA 119. In some instances, the one or more inputs can be provided using the user interface 182b of the client device 109.

At block 316, the software module 194 of the client application 193 can send the acquisition order to the PAEA 119. In some instances, the acquisition order can contain a product 186 or service to be automatically purchased or reserved. In other instances, the acquisition order can contain a plurality of products 186 to be automatically purchased or reserved. In some examples, the acquisition order can contain a combination of products 186 and services to be purchased and/or reserved.

At block 319, the software module 194 of the client application 193 can authenticate the acquisition order based at least in part on the credentials 196. In other examples, the client application 193 can authenticate the acquisition order based at least in part on the secure user authorized method.

At block 323, the software module 194 of the client application 193 can select a payment method for the acquisition order. In other instances, the client application 193 can provide a new or alternative payment method 143. In other examples, the client application 193 can provide multiple payment methods 143 to complete the acquisition order.

At block 326, the software module 194 of the client application 193 can receive a first notification from the PAEA 119. In other examples, the client application 193 can receive the first notification from the merchant application 179. In other examples, the first notification can comprise an order confirmation.

At block 329, the software module 194 of the client application 193 can receive a second notification from the PAEA 119. In other examples, the client application 193 can receive the second notification from the merchant application 179. In other examples, the second notification can comprise an acquisition order completion message. In other examples, the second notification can comprise an acquisition order modification request.

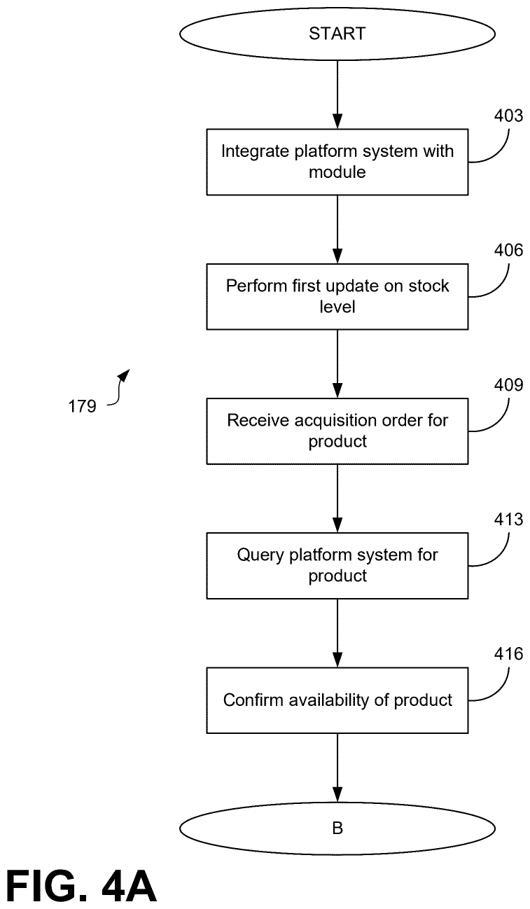

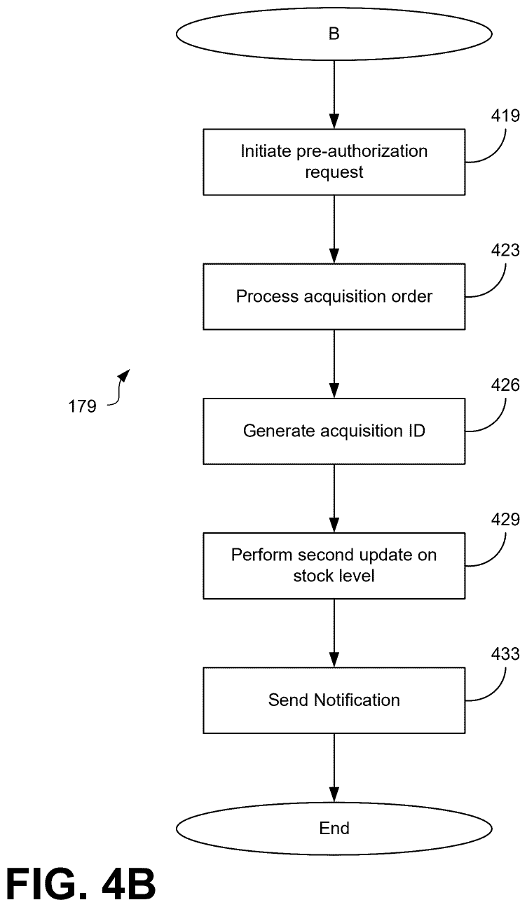

Referring next to FIGS. 4A and 4B, shown is a flowchart that provides one example of the operation of a portion of the product acquisition enhancement application 119. The flowchart of FIGS. 4A and 4B provides merely an example of the many different types of functional arrangements that can be employed to implement the operation of the depicted portion of the product acquisition enhancement application 119. As an alternative, the flowchart of FIGS. 4A and 4B can be viewed as depicting an example of elements of a method implemented within the network environment 100.

Beginning with block 403, the merchant application 179 of the merchant device 106 can integrate the platform system with the merchant application 179. In some examples, the merchant application 179 can integrate the platform system with the PAEA 119. The platform system can be the ecommerce platform. In other examples, the platform system can be the digital marketplace. In other examples, the platform system can be used by the merchant to showcase products 186, services, manage inventory, and other potential actions.

At block 406, the merchant application 179 of the merchant device 106 can perform a first update on a stock level 187 of the one or more products 186. In some examples, the first update can be used to update the inventory status 169.

At block 409, the merchant application 179 of the merchant device 106 can receive an acquisition order for an individual product. In some instances, the acquisition order can contain product details 146 or product information 149. In some other examples, the acquisition order can contain user inputs. The user inputs can be quantity, size, color, and other relevant details input or chosen by the user. In some instances, the user inputs can be varied based at least in part on the products 186 and/or services selected for the acquisition order.

At block 413, the merchant application 179 of the merchant device 106 can query the platform system for the stock level 187 of the product 186. In some instances, the merchant application 179 can query the platform system based at least in part on the user inputs.

At block 416, the merchant application 179 of the merchant device 106 can confirm the availability of the product 186 based at least in part on querying the platform system. In some examples, the merchant application 179 can confirm the availability of the product 186 based at least in part on the stock levels 187. In some examples, confirming the availability of the product 186 can require manually checking the product 186 available on hand.

At block 419, the merchant application 179 of the merchant device 106 can initiate the pre-authorization request for the acquisition order. The pre-authorization could be reserving a set sum or the acquisition order total from the financial institution of the user. In some instances, the funds could be reserved on the selected payment method 143.

At block 423, the merchant application 179 of the merchant device 106 can process the acquisition order based at least in part on a completed pre-authorization charge. In some instances, the merchant application 179 can process the acquisition order based at least in part on availability of the product 186. The merchant application 179 can execute the payment processing service 183 to authorize the total of the acquisition order from the one or more payment methods 143 chosen by the user.

At block 426, the merchant application 179 of the merchant device 106 can generate an acquisition ID for the acquisition order. In some instances, the acquisition ID can be the transaction ID 159. The acquisition ID can be randomly generated, input manually, or be based off a custom pattern. In some instances, the acquisition ID can be used to track the acquisition order.

At block 429, the merchant application 179 of the merchant device 106 can perform a second update on the stock level 187 based at least in part on the acquisition order. The second update can be used to update the inventory status 169 after the acquisition order. In other examples, the second update can be used to correct any discrepancies in the stock levels 187.

At block 433, the merchant application 179 of the merchant device 106 can send a notification. In some instances, the merchant application 179 can send the notification to the merchant service 123 of the PAEA 119. In other examples, the merchant application 179 can send a notification to the client application 193 or the software module 194 of the client device 109. In some instances, the notification can comprise an acquisition ID. In other examples, the notification can comprise an order cancellation or order modification notice. In some other examples, the notification can comprise a recommendation or suggestion for an alternate product 186.

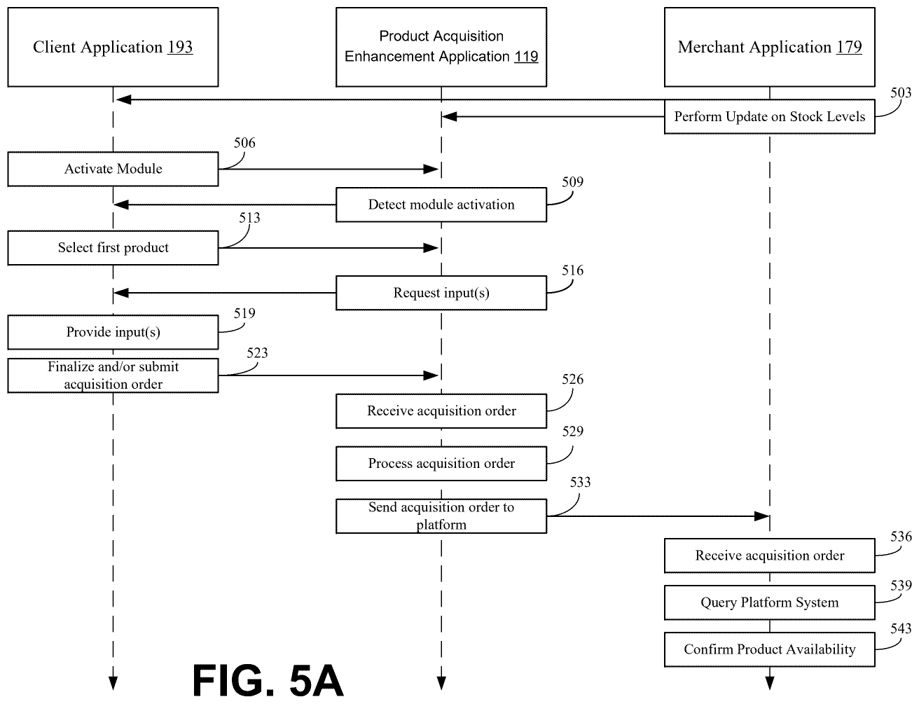

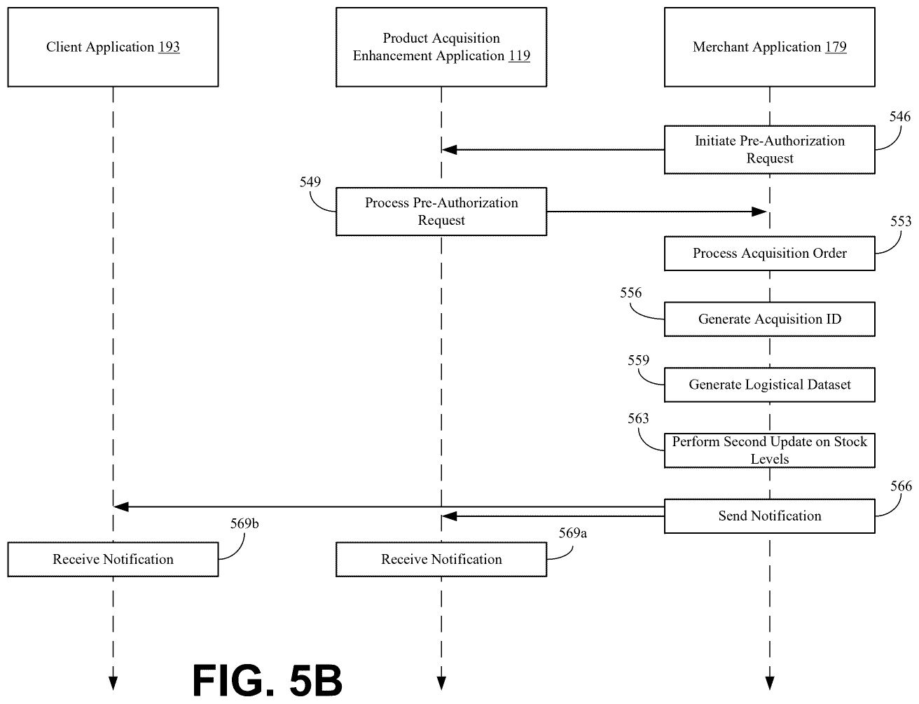

Referring next to FIGS. 5A and 5B, shown is a sequence diagram illustrating one example of the interaction between the client application 193, the PAEA 119, and the merchant application 179 according to various embodiments. The sequence diagrams of FIGS. 5A and 5B provide merely an example of the many different types of interactions between the client application 193, the PAEA 119, and the merchant application 179. As an alternative, the sequence diagram of FIGS. 5A and 5B can be viewed as depicting an example of elements of a method implemented within the network environment 100.

Beginning with block 503, the merchant application 179 of the merchant device 106 can perform a first update on a stock level 187 of a product 186. In some examples, the first update can be used up update the inventory status 169.

At block 506, the software module 194 in the client application 193 of the client device 109 can activate the PAEA 119. In some examples, the software module 194 can be executed by launching the browser plug-in, navigating to the web application, launching the computer application, or launching the mobile application.

At block 509, the product acquisition enhancement application 119 can receive a trigger event that the user service 126 of PAEA 119 has been activated by the user or the client application 193. In some instances, the user service 126 of the PAEA 119 can detect the PAEA 119 has been activated by the user.

At block 513, the client application 193 of the client device 109 can select a product 186 with a first availability. In some examples, the software module 194 can select a product 186. In some instances, the product 186 could be selected by the software module 194 or the client application 193 based at least in part on an input from the user via the user interface 182b. In some instances, the first availability could reflect an out-of-stock product. In other instances, the first availability can reflect an unavailable product.

At block 516, the user service 126 of the product acquisition enhancement application 119 can request one or more inputs for the products from the user via the software module 194. In some instances, the one or more inputs can be requested from the client application 193. In other instances, the PAEA 119 can auto-fill one or more inputs based at least in part on the user profile 129.

At block 519, the software module 194 of the client device 109 can provide one or more inputs requested by the user service 126 of the PAEA 119 in block 516 using the user interface generated by the software module 194 or the client application 193. In some instances, the software module 194 can provide a plurality of inputs to the PAEA 119. In some instances, the one or more inputs can be provided using the user interface 182b of the client device 109. In some examples, the user inputs can be prefilled based at least in part on the user profile. In other examples, the inputs can be at least one of providing a quantity, maximum price, or a maximum time frame to automatically purchase. In other examples, the inputs can be at least one or more of providing a color, size, width, length, etc. based at least in part on the product information 149 or the product details 146.

At block 523, the software module 194 of the client application 193 of the client device 109 can authenticate the acquisition order and submit the acquisition order to the PAEA 119. In some instances, the user could be logged in and would not need to authenticate to submit the acquisition order. In some examples, the user could authenticate the acquisition order by providing a password, two-factor authentication, or biometric.

At block 526, the product acquisition enhancement application 119 can receive an acquisition order from the user via the software module 194 accessed as a plug-in of the client application 193. In some instances, the acquisition order can be for a plurality of products 186. In some examples, the acquisition order can be authenticated based at least in part on the credentials 196 provided by the user. In other instances, the order can be authenticated by a secure user authorized method. The secure user authorized method can be at least one or more of a password authentication, a multi-factor authentication, or a biometric authentication.

At block 529, the product acquisition enhancement application 119 can process the acquisition order. In some examples, the PAEA 119 can verify the user inputs and product details. In other examples, the PAEA 119 can validate the user inputs based at least in part on the user profile 129.

At block 533, the product acquisition enhancement application 119 can send the acquisition order to the merchant platform. In some instances, the acquisition order can be sent to the merchant application 179.

At block 536, the merchant application 179 of the merchant device 106 can receive the acquisition order from the PAEA 119. In some instances, the acquisition order can contain a plurality of products 186. In some instances, the acquisition order can contain product details 146 or product information 149. In some other examples, the acquisition order can contain user inputs. The user inputs can be quantity, size, color, and other relevant details input or chosen by the user. In some instances, the user inputs can be varied based at least in part on the products 186 and/or services selected for the acquisition order.

At block 539, the merchant application 179 of the merchant device 106 can query the stock levels 187 for real-time inventory information for a product 186 in the acquisition order. In some instances, the merchant application 179 can query the platform system based at least in part on the user inputs.

At block 543, the merchant application 179 of the merchant device 106 can confirm the availability of the product requested in the acquisition order. In some examples, the merchant application 179 can confirm the availability of the product 186 based at least in part on the stock levels 187. In some examples, confirming the availability of the product 186 can require manually checking the product 186 available on hand.

At block 546, the merchant application 179 of the merchant device 106 can initiate a payment pre-authorization request prior to fulfilling the acquisition order. In other instances, the merchant application 179 can initiate a payment pre-authorization request upon receipt of the acquisition order. The pre-authorization could be reserving a set sum or the acquisition order total from the financial institution of the user. In some instances, the funds could be reserved on the selected payment method 143.

At block 549, the product acquisition enhancement application 119 can process the pre-authorization request. In some instances, processing the pre-authorization request can comprise providing, through a secure or encrypted methods, information for the payment method 143.

At block 553, the merchant application 179 of the merchant device 106 can process the acquisition order. In some examples, the merchant application 179 can process the acquisition order based at least in part on a completed pre-authorization charge. In some instances, the merchant application 179 can process the acquisition order based at least in part on availability of the product 186. The merchant application 179 can execute the payment processing service 183 to authorize the total of the acquisition order from the one or more payment methods 143 chosen by the user.

At block 556, the merchant application 179 of the merchant device 106 can generate an acquisition ID for the acquisition order. In some instances, the acquisition ID can be the transaction ID 159. The acquisition ID can be randomly generated, input manually, or be based off a custom pattern. In some instances, the acquisition ID can be used to track the acquisition order.

At block 559, the merchant application 179 of the merchant device 106 can generate a logistical dataset for the acquisition order. In some instances, the logistical dataset can comprise information for product fulfilment. In other instances, the logistical dataset can comprise tracking information for the products 186 purchased using the PAEA 119. In other instances, the logistical dataset can comprise delivery estimate, “ready for pickup” times, and other relevant package/parcel information.

At block 563, the merchant application 179 of the merchant device 106 can perform a second update on the stock levels 187. In some examples, the merchant application 179 can perform a second update on the stock level 187 based at least in part on the acquisition order. The second update can be used to update the inventory status 169 after the acquisition order. In other examples, the second update can be used to correct any discrepancies in the stock levels 187.

At block 566, the merchant application 179 of the merchant device 106 can send a notification to the PAEA 119. The merchant application 179 can also send a notification to the software module 194 of the client application 193. In some instances, the PAEA 119 can send a notification to the client application 193. The merchant application 179 can compile one or more of the acquisition ID, order status update, or product recommendation for the notification. Next, the merchant application 179 via secure APIs or other encrypted channels, can send a notification to the PAEA 119, the client application 193, or the software module 194. In some instances, the merchant application 179 can configure the notification to be sent instantly or at a scheduled time. In some instances, the notification can comprise an acquisition ID. In other examples, the notification can comprise an order cancellation or order modification notice. In some other examples, the notification can comprise a recommendation or suggestion for an alternate product 186. In some examples, the notification can comprise a message from the merchant.

At block 569a, the product acquisition enhancement application 119 can receive a notification from the merchant application 179. The PAEA 119 can receive the notification from the merchant application 179 through a push-service configured to send notification. In other examples, the notification can be verified, parsed, and stored in the data store 116. The PAEA 119 can update the data stored in the data store 116 based at least in part on the notification. In some instances, the notification can comprise an acquisition ID. In other examples, the notification can comprise an order cancellation or order modification notice. In some other examples, the notification can comprise a recommendation or suggestion for an alternate product 186. In some examples, the notification can be used to communicate a message to the PAEA 119. In other examples, the notification can be sent to the PAEA 119 from the merchant if the merchant does not have permission or information of the user.

At block 569b, the software module 194 of the client application 193 of the client device 109 can receive a notification from the merchant application 179. In some instances, the client application 193 can use background services to listen for incoming notification. In other examples, the client application 193 can use a push notification service configured to listen for or receive notifications. The notification can be routed through a notification server prior to being received by the client application 193. In some instances, the notification can comprise an acquisition ID. In other examples, the notification can comprise an order cancellation or order modification notice. In some other examples, the notification can comprise a recommendation or suggestion for an alternate product 186. In some examples, the notification could be a personalized message for the user from the merchant. After block 569b, the sequence diagram of FIG. 5 ends.

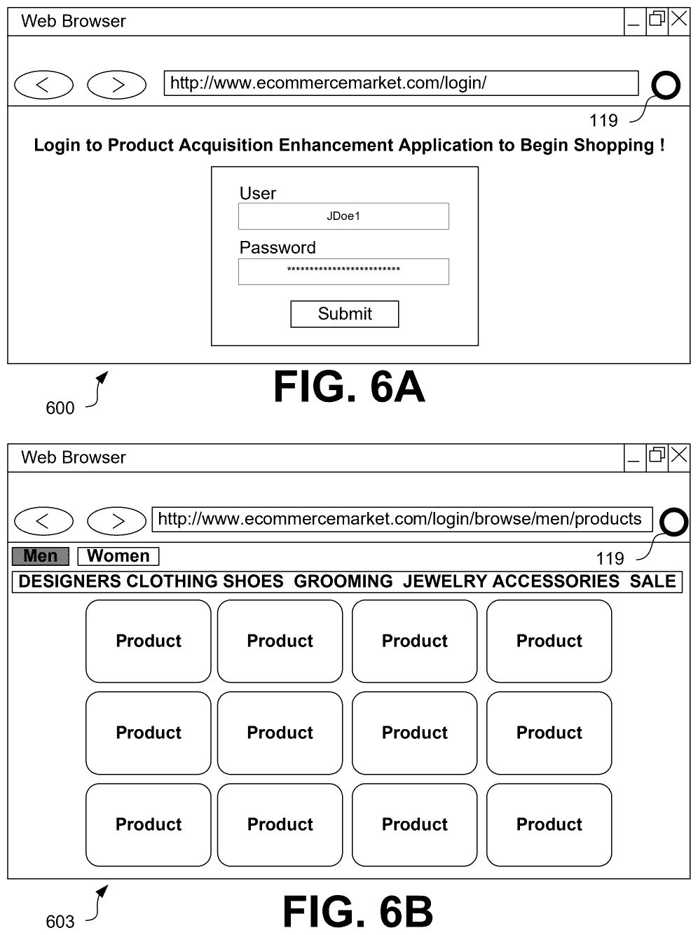

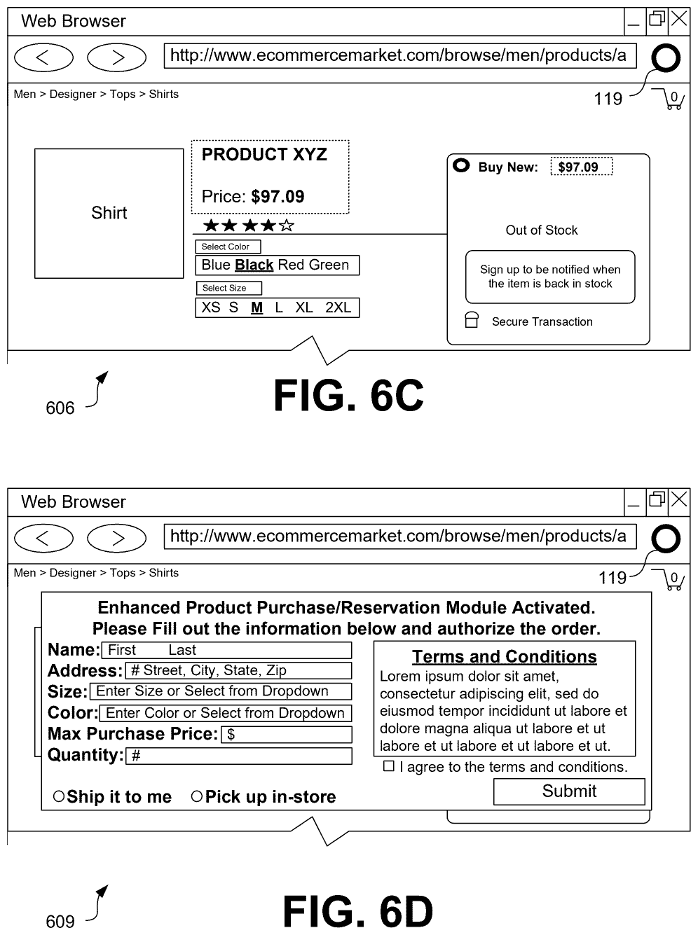

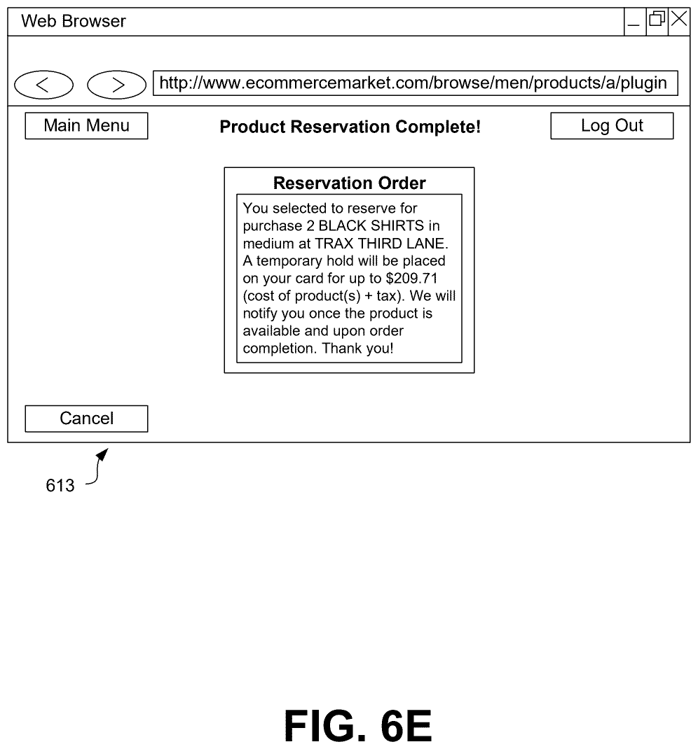

FIGS. 6A-6E depict various examples of scenarios where a user could be browsing an e-commerce platform looking to purchase a product and using the browser plugin to complete the purchase and/or reservation of a product according to various embodiments of the present disclosure. In each of these examples, a user is able to use the plugin to complete an acquisition order or product reservation. For example, a user could request to purchase an out-of-stock item when it is available in stock without having to spend time on the e-commerce platform.

Referring to FIGS. 6A-6E, shown is a user interface diagram 600, 603, 606, 609, and 613, displayed on a display 181b (FIG. 1) of the client device 109 (FIG. 1). In some instances, the user interface 182b (FIG. 1) can be rendered on the display 181b by a web browser. In other instances, the user interface 182b can be rendered and displayed on a dedicated application, a mobile application, or other related environments, where the software module 194 can be the application, be integrated into the application, or be an extension of the application. The user interface 182b represents an application to request a product reservation using the product acquisition enhancement application 119. The user interface 182b can be rendered by the client application 193 (FIG. 1). In some instances, the user interface 182 can be rendered by the software module 194.

With reference to FIG. 6A, the user interface diagram 600 provides affordances for the user to input credentials, (e.g., username and password, biometrics, physical security key, etc.) to shop on an ecommerce platform with the product acquisition enhancement application 119. The user interface 182b of the client device 109 can be used to input the requested username and password. In some instances, an input device can be used to input the requested credentials. Once the credentials 196 are entered, the user can click the “Submit” button to submit the credentials for authentication. In some examples, the credentials 196 can be based at least in part on a user account profile 129.

Referring next to FIG. 6B, in this example, the user interface diagram 603 displays the following screen that shows the user provided credentials are authenticated to continue shopping on the ecommerce platform using the PAEA 119. The user can be presented with a plurality of products 186 that are associated with the merchant. In some examples, the products 186 can be presented with an image of the product 186. The user can select one of the products 186 to continue shopping. The product 186 can be selected by clicking on the image of the product 186. In some other examples, the products 186 can be selected via a drop-down menu. In some other examples, the products 186 could be selected from the list of products 186. In this instance, the user interface 182b of the client device 109 includes a plurality of products depicted by the image of the products 186. In some examples, the user can add to cart one or more products 186. If the user does not want to shop a specific section, they can proceed to press any of the buttons such as “men” or “women” to browse other products 186. In some examples, the user can terminate the session by clicking a log out button. In some instances, clicking the log out button will redirect the user to the user interface of FIG. 6A.

Referring next to FIG. 6C, the user has selected a product 186 to navigate to a product information page. The user interface 182b can display the product 186 selected by the user with the respective information of the product 186. The user interface 182b also displays current pricing, inventory status (e.g., available, out of stock, no longer available, etc.), and other relevant information. In some examples, the user could be offered product options to be selected such as color, size, style, and other relevant options. In other examples, the user will be offered an option to receive a notification when the item is back in stock if the current status of the product 186 is out of stock. In some examples, the user interface 182b could further include an input box for the user to input a value for the quantity of product 186 to purchase. In some examples, the user can only input a value that is less than or equal to the stock level 187 of the product 186. The user can input up to the maximum quantity of the product 186 as allowed by the stock level 187 and the total quantity can be reflected on the user interface 182b. In this instance, the user has selected product “XYZ” that is current “out of stock.” In some examples, pressing the “Cancel” or “Back” button can redirect the user to the main menu. In other examples, pressing the “Cancel” or “Back” button can redirect the user to the previous page. In some instances, the user can terminate the session by clicking the “log out” button. In some instances, clicking the “log out” button can redirect the user to the user interface of FIG. 6A. The user can execute the PAEA 119 by clicking the icon for the PAEA 119.

Referring next to FIG. 6D, the user activated the PAEA 119 to place an acquisition order to automatically purchase an out-of-stock item upon availability. The user interface 609 can display an overlay on the user interface 182b on the display 181b of the client device 109. The user interface 609 can request one or more inputs from the user to place an acquisition order. In this example, the user can finalize and submit the fulfillment of the acquisition order by clicking the “Submit” button. In this example, the user can terminate the session by clicking the “Log out” button. The user can navigate to the main menu of the transaction account management user interface by clicking the “main menu” button.

Referring next to FIG. 6E, the user is presented with a user interface 613 after selecting to submit an acquisition order. In some embodiments, the user interface 806 can include a message or a notification to notify the user of the acquisition order. In this example, the user can terminate the session by clicking the “Log out” button. The user can navigate to the main menu by clicking the “Main Menu” button. If the user does not want to continue with the acquisition order, the user can cancel by clicking the “Cancel” button. In some examples, pressing the “Cancel” button can redirect the user to the main menu. In other examples, pressing the “Cancel” button can redirect the user to the previous page.

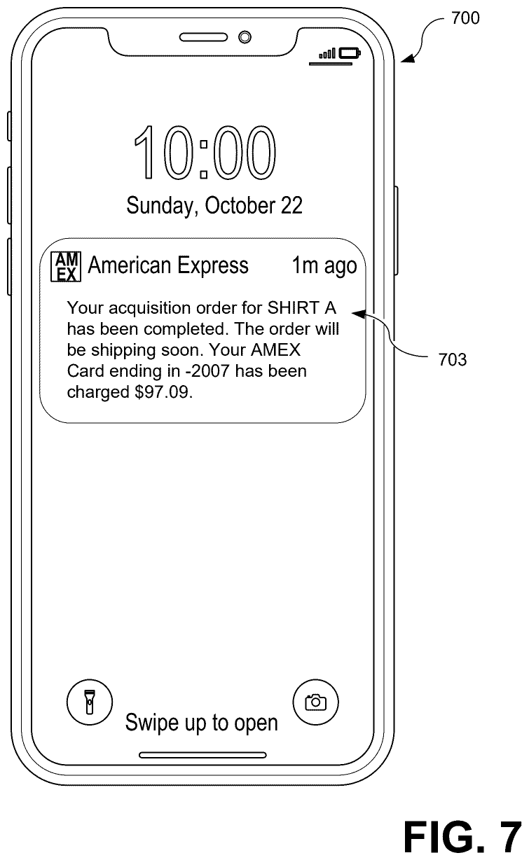

FIG. 7 depicts a client device 700, presenting the user with a notification 703 on the display 181b of the client device 700. In some examples, the notification could provide the user with a first notification. In some other examples, the notification could provide the user with a second notification. In other examples, the notification could remind the user of the product recommendations and/or suggestions.

In another example, such as the example depicted in FIG. 7, the client device 700 of the user could receive a notification 703 after the transaction 139 (FIG. 1) has been completed, acquisition is completed, package has shipped, product 186 is ready for pick-up or the reservation request is completed. If a user completes a transaction with a reward qualifier (e.g., using MR points, coupons, discount, sales, loyalty points, etc.), the user could receive a notification 703 on his or her client device 700 informing the user that the transaction is ineligible for the reward qualifier.

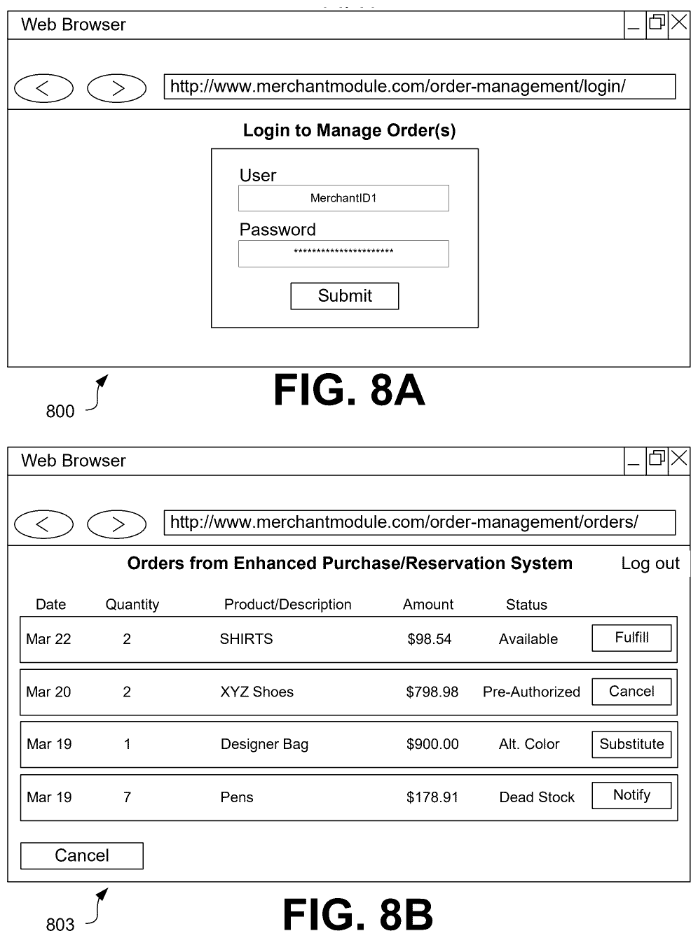

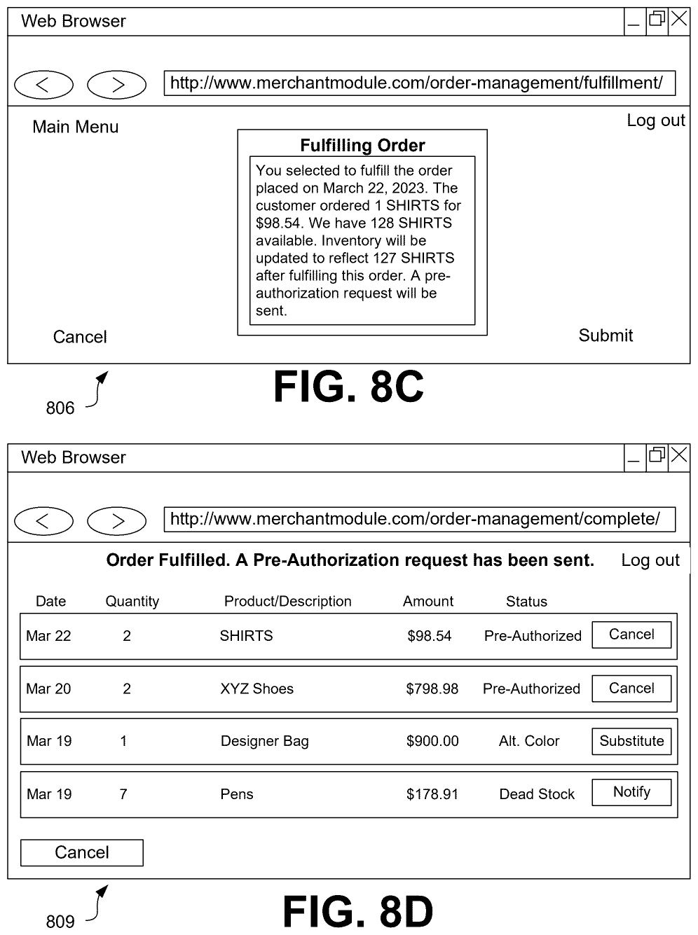

FIGS. 8A-8D depict various examples of scenarios where the merchant could begin managing and/or processing an acquisition order and product reservation request according to various embodiments of the present disclosure. In each of these examples, a merchant is able to login in to manage the transaction associated with an acquisition order or product reservation request. For example, a merchant could fulfill an order for two shirts that are available in the inventory.

Referring to FIGS. 8A-8D, shown is a user interface diagram 800, 803, 806, and 809, displayed on a display 181a (FIG. 1) of the merchant device 106 (FIG. 1). In some instances, the user interface 182a (FIG. 1) can be rendered on the display 181a by a web browser. In other instances, the user interface 182a can be rendered and displayed on a dedicated application, a mobile application, or other related environments. The user interface 182a represents an application to fulfill, cancel, or modify a product reservation using the product acquisition enhancement application 119. The user interface 182a can be rendered by the merchant application 179 (FIG. 1).

With reference to FIG. 8A, the user interface diagram 800 provides affordances for the merchant to input credentials, (e.g., username and password, biometrics, physical security key, etc.) to log into the merchant platform with the product acquisition enhancement application 119. The user interface 182a of the merchant device 106 can be used to input the requested username and password. In some instances, an input device can be used to input the requested credentials. Once the merchant credentials are entered, the merchant can click the “Submit” button to submit the credentials for authentication. In some examples, the merchant credentials can be based at least in part on a merchant ID 153.

Referring next to FIG. 8B, the user was authenticated with the PAEA 119 to manage one or more transactions 139 or acquisition orders. The merchant can select one of the transactions 139 to be fulfilled, canceled, substituted with another product 186, or to notify the user. In some embodiments, the acquisition order could be unavailable to be fulfilled. In some examples, the acquisition order can be fulfilled and completed. The acquisition order can be selected by clicking the transaction record 156 (FIG. 1). In some other examples, the acquisition order can be selected via a drop-down menu. If the merchant does not want to manage any orders, the merchant can cancel the order by clicking the “Cancel” button. In some examples, pressing the “Cancel” button can redirect the merchant to the main menu. In other examples, pressing the “Cancel” button can redirect the merchant to the previous page. The merchant can terminate the session by clicking the “log out” button. In some instances, clicking the “Log out” button will redirect the merchant to the user interface of FIG. 8A.

Referring next to FIG. 8C, the merchant is presented with a user interface 806 after selecting to fulfill an acquisition order. In some embodiments, the user interface 806 can include a message or a notification to notify the merchant of product fulfilment step. In this example, the merchant can finalize and submit the fulfillment of the acquisition order by clicking the “Submit” button. In this example, the merchant can terminate the session by clicking the “Log out” button. The user can navigate to the main menu of the PAEA 119 user interface by clicking the “Main Menu” button. If the merchant does not want to continue with fulfillment of the acquisition order, the merchant can cancel by clicking the “Cancel” button. In some examples, pressing the “Cancel” button can redirect the merchant to the main menu. In other examples, pressing the “Cancel” button can redirect the merchant to the previous page.

Referring next to FIG. 8D, the merchant is presented with a user interface 809 that shows the acquisition orders or transactions 139 after successfully fulfilling an acquisition order. In some examples, the user interface can display the list of transactions 139 and an updated acquisition order status. In some embodiments, the acquisition order status can change to “pre-authorized” or similar terms to indicate the transaction has been fulfilled and pending payment. In some embodiments, the user interface 809 can include a message or a notification to notify the merchant of the status of the acquisition order. In this example, the user can terminate the session by clicking the “Log out” button. In some embodiments, the merchant can navigate to the main menu by clicking the “Main Menu” button. In some examples, pressing the “Cancel” button can redirect the merchant to the main menu.

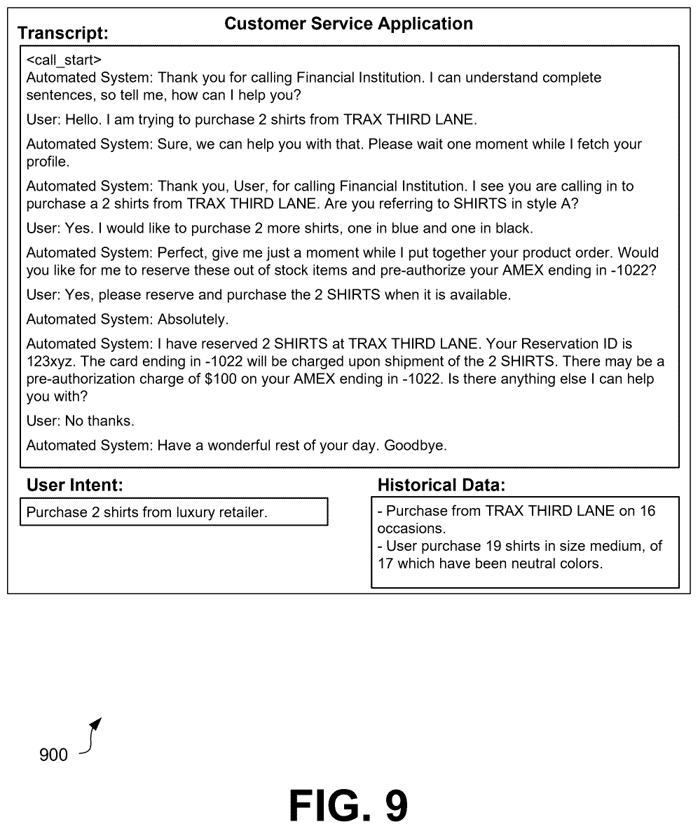

Referring to FIG. 9, shown is a user interface diagram 900 displayed on a display 181b (FIG. 1) of a client device 109 (FIG. 1). In some instances, the user interface 182b (FIG. 1) can be rendered on the display 181b by a web browser. In other instances, the user interface 182b can be rendered and displayed on a dedicated application, a mobile application, or other related environments. The user interface 182b represents an application for interacting with a customer service bot or agent and automatically placing an acquisition order. The user interface 182b can be rendered by a client application 193 (FIG. 1).

With reference to FIG. 9, displayed is the user interface 182b of the client application 193 on the display 181b of the client device 109 on the user interface 182b. The agent can be presented with a transcript of the conversation in real-time. In some instances, the user interface 900 can display the user intent or user profile 129 (FIG. 1), product details 146 (FIG. 1), the merchant ID 153 (FIG. 1), the user information 133 (FIG. 1), and/or the recommendations/suggestions. A speech-to-text engine can transcribe the call and present the text on the transcript. Based on the transcript, a natural language processing application can process the conversation and determine the intent of a user. In some instances, the user intent can be manually input or corrected by a customer service agent. The user profile 129 can provide information such as past purchases, merchant loyalty, favorite products, and other similar data about the user. In other embodiments, the user interface 900 can display specific details about the user from the user profile 129. For example, the user interface 900 can display a user's transaction account and membership reward points. In some examples, the user interface 900 can display the product recommendations. The product recommendations can be updated to provide an updated recommendations as the conversation progresses. For example, the first user intent is to purchase 2 shirts from TRAX THIRD LANE. The first recommendation can be for an automated system or agent to ask the user if they want to purchase the shirt in a size medium in a neutral color. An updated recommendation can be for an automated system or agent to ask the user is they want to purchase 2 shoes at TRAX THIRD LANE in size 8.0 and pay for the acquisition order using the user's “Platinum” credit card.

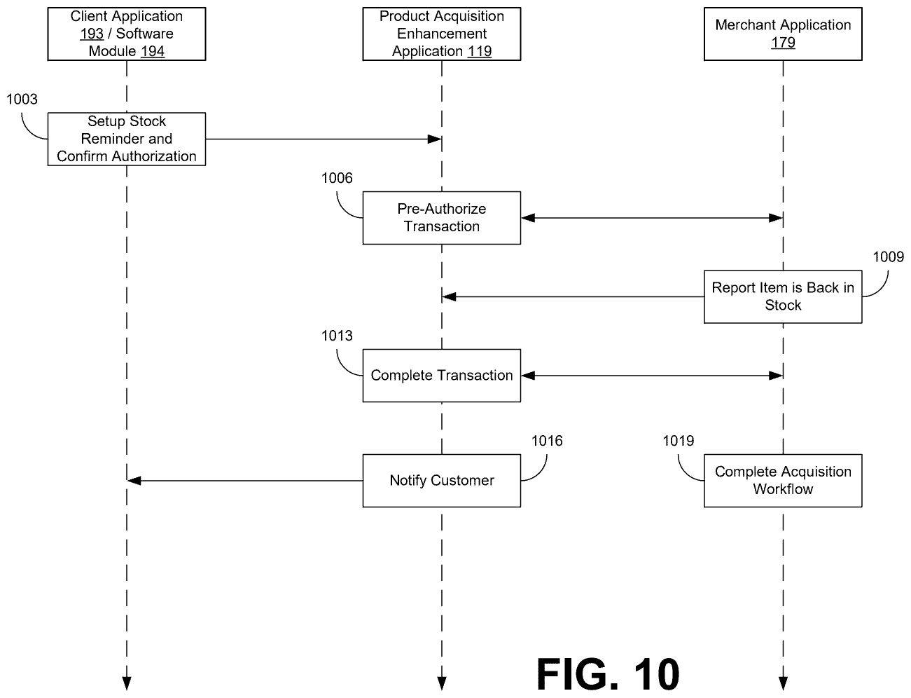

FIG. 10 depicts a sequence diagram according to various embodiments of the present disclosure. Although FIG. 10 depicts an example of the interactions between the client application 193 or software module 194, the PAEA 119, and the merchant application 179, other interactions between the client application 193 or software module 194, the PAEA 119, and the merchant application 179 are also encompassed by the various embodiments of the present disclosure. For example, one or more operations depicted in FIG. 2A, 2B, 3A, 3B, 4A, 4B, 5A, or 5B could be performed in combination with one or more of the operations depicted and described in FIG. 10.

Beginning with block 1003, the client application 193 or the software module 194 could setup a stock reminder and confirm authorization for payment to purchase or acquire an item with the merchant. This could be submitted to the PAEA 119, for example, in response to a user of the client application 193 or software module 194 attempting or desiring to place an order for an item that is currently out of stock with the merchant. The confirmation authorization could include information such as the amount of the item, the payment instrument to use, the purchase price for the item(s), and an indication that the user has authorized the payment. The stock reminder could include information such as the stock keeping unit (SKU) of the item, the location of the item (e.g., store identifier where the item will be purchased or picked up from), and other item specific information (e.g., size, color, quantity, etc.).

At block 1006, the PAEA 119 can preauthorize the transaction on behalf of the user. This could cause the PAEA 119 to place a hold for a specified amount (e.g., the price of the item). The hold could last until the item is reported back in stock in order to ensure that the user has sufficient funds to pay the merchant for the item when the transaction is completed.

Next, at block 1009, the merchant application 179 can report to the PAEA 119 that the item is back in stock. This could be done, for example, in response to the merchant receiving new inventory and updating their inventory management systems. The merchant application 179, in such situations, could poll or otherwise monitor the inventory management systems to determine when the item was back in stock. In other situations, the inventory management system could send a notification to the merchant application 179 that the item was back in stock.

Moving on to block 1013, the PAEA 119 can complete the transaction that was pre-authorized at block 1006. This could include processing the payment and/or transferring funds from the account of the user to the account of the merchant. Once the transaction is completed, the PAEA 119 could notify the merchant application 179 to allow the merchant to complete the acquisition workflow.

Then, at block 1016, the PAEA 119 can notify the user that the transaction has been completed. The PAEA 119 could send a notification to the user through one or more channels. For example, the PAEA 119 could send a notification via email, short message service (SMS) message, an in-application notification pushed or sent to the client application 193 or software module 194 as appropriate, etc.

Subsequently, at block 1019, the merchant application 179 could complete the acquisition workflow. For example, the merchant application 179 could initiate a workflow whereby the merchant ships the item(s) to the user. As another example, the merchant application 179 could send a notification to store or other merchant location to notify an employee to pull the item from inventory for in-store pickup by the user. Other workflows could also be initiated according to various embodiments of the present disclosure.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and the sequence diagram show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and the sequence diagram show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 103.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A method, comprising:
receiving an acquisition order for the product based at least in part on a first availability of the product;
receiving one or more user inputs for the product;
processing the acquisition order for the product based at least in part on the one or more user inputs;
detecting a second availability for the product based at least in part on the plurality of platform data; and
acquiring the product based at least in part on the second availability.

2. The method of claim 1, further comprising querying the platform at a set time interval to update the plurality of platform data.

3. The method of claim 1, further comprising sending a notification based at least in part on the second availability or completing the acquisition order, wherein the notification is dispatched through one or more channels selected by a user.

4. The method of claim 3, wherein the one or more user inputs comprise one or more of: a price range, a product color, a product quantity, or a product size.

5. The method of claim 1, wherein initiating the acquisition order further comprises at least one of applying user rewards, discount codes, or initiating a pre-authorization for the product.

6. The method of claim 1, wherein finalizing the acquisition order further comprises interfacing with one or more payment systems to process the acquisition order.

7. The method of claim 1, further comprising generating a logistical dataset based at least in part on the acquisition order.

8. A system, comprising:
a computing device comprising a processor, a memory, and a display; and
machine-readable instructions stored in the memory that, when executed by the processor, cause the computing device to at least:
install a software module on a user device;
execute the software module;
select a product on a platform with a first availability;
provide a plurality of inputs for the product in the software module;
send an acquisition order for the product;
authenticate the acquisition order;
receive a notification; and
show the notification on the display of the computing device.

9. The system of claim 8, wherein the notification comprises at least one of an acquisition ID, the first availability, or a second availability.

10. The system of claim 8, wherein the plurality of inputs are provided through a user interface for the software module.

11. The system of claim 8, wherein the software module provides one or more alternative products based at least in part on a third availability and the plurality of inputs.

12. The system of claim 8, wherein the software module further comprises a user interface to display one or more of the notification, an acquisition order history, or a profile.

13. The system of claim 8, wherein sending the acquisition order further comprises providing a pre-authorization method to process the acquisition order based at least in part on a second availability.

14. The system of claim 8, wherein the acquisition order is authenticated through a secure user authorized method, wherein the secure user authorized method is at least one or more of a password authentication, a one-time passcode, a multi-factor authentication, or a biometric authentication.

15. A non-transitory, computer-readable medium, comprising machine-readable instructions that, when executed by a processor of a computing device, cause the computing device to at least:
initiate a pre-authorization request in response to receipt of an acquisition order for a product from a client device;
process the acquisition order for the product;
generate an acquisition ID for the acquisition order;
perform an update on the stock level for the product; and
send a notification to the client device, the notification representing the update on the stock level for the product.

16. The non-transitory, computer-readable medium of claim 15, wherein the user profile comprises at least one or more of user inputs, user history, or a purchase method.

17. The non-transitory, computer-readable medium of claim 15, wherein the update on the stock level is activated by at least one or more of an inventory audit, a vendor input, or a product replenishment.

18. The non-transitory, computer-readable medium of claim 15, wherein the notification is dynamically generated based at least in part on the availability of the individual product, wherein the notification further comprises the acquisition ID.

19. The non-transitory, computer-readable medium of claim 15, wherein the software module is configured to use at least one or more encryption algorithms to transfer data to the platform system.

20. The non-transitory, computer-readable medium of claim 15, wherein the machine-readable instructions, when executed by the processor, further cause the computing device to generate a logistical dataset based at least in part on the acquisition ID and the acquisition order.
